(19) United States
(12) Patent Application Publication
(10) Pub. No.: US 2026/0341564 A1
(43) Pub. Date: Oct. 29, 2026

(54) SOFT MAGNETIC METAL POWDER, MAGNETIC CORE, MAGNETIC COMPONENT, AND ELECTRONIC DEVICE

(71) Applicant: TDK CORPORATION, Tokyo (JP)

(72) Inventors: Satoko MORI, Tokyo (JP); Kazuhiro YOSHIDOME, Tokyo (JP)

(73) Assignee: TDK CORPORATION, Tokyo (JP)

(21) Appl. No.: 19/655,145

(22) Filed: Apr. 22, 2026

(30) Foreign Application Priority Data
Apr. 25, 2025 (JP) 2025-073316

(51) Int. Cl. H01F 1/20; B22F 1/16

(52) U.S. Cl. CPC H01F 1/20; B22F 1/16; B22F 2301/35; B22F 2302/25

(57) ABSTRACT

A soft magnetic metal powder includes a soft magnetic metal particle including a core part and a covering part. The soft magnetic metal particle comprises Fe. The covering part includes an oxide layer contacting a surface of the core part. The oxide layer includes a second layer contacting the surface of the core part and a first layer contacting the second layer. The first layer and the second layer include an oxide of an element included in the core part. The first layer has an uneven luminance distribution compared to the second layer in a cross section of the soft magnetic metal particle observed using HAADF-STEM.

### TECHNICAL FIELD

The present disclosure relates to a soft magnetic metal powder, a magnetic core, a magnetic component, and an electronic device.

### BACKGROUND

Patent Document 1 discloses a core using a composite magnetic material made by mixing an insulation binder with a magnetic powder mixture obtained by mixing an iron-based crystalline alloy magnetic powder and an iron-based amorphous alloy powder.

Patent Document 2 discloses a heat curable resin coating each particle included in a magnetic powder mixture obtained by mixing a hard amorphous alloy magnetic powder and a Fe—Ni-based alloy magnetic powder to give a composite magnetic material. Patent Document 2 discloses an inductor using such composite magnetic material.

### PRIOR ART DOCUMENT

### Patent Document

[Patent Document 1] JP Patent Application No. 2004-197218A
[Patent Document 2] JP Patent Application No. 2004-363466A

### SUMMARY

A soft magnetic metal powder according to the present disclosure includes: a soft magnetic metal particle including a core part and a covering part, wherein the soft magnetic metal particle includes Fe, the covering part includes an oxide layer contacting a surface of the core part, the oxide layer includes a second layer contacting the surface of the core part and a first layer contacting the second layer, the first layer and the second layer include an oxide of an element included in the core part, and the first layer has an uneven luminance distribution compared to the second layer in a cross section of the soft magnetic metal particle observed using HAADF-STEM.

### BRIEF DESCRIPTION OF DRAWINGS

FIG. 1 is a schematic cross-sectional view of a soft magnetic metal particle.

FIG. 2 is an example chart generated using an X-ray crystallography.

FIG. 3 is an example pattern obtained by profile fitting the chart of FIG. 2.

FIG. 4 is a HAADF-STEM image of a cross section of a soft magnetic metal particle.

FIG. 5 is a partial image of FIG. 4.

FIG. 6 is a binarized image of FIG. 5.

FIG. 7 is an image in which two hypothetical lines are drawn on FIG. 6.

FIG. 8 is a schematic cross-sectional view of a powder coating device.

### DETAILED DESCRIPTION

It is an object of the present disclosure to provide a soft magnetic metal powder which is less likely to have a lowered withstand voltage even when molding is conducted under high pressure.

In the soft magnetic metal powder according to the present disclosure, a binarized image having a high-luminance region and a low-luminance region obtained by observing the cross section of the soft magnetic metal particle using HAADF-STEM may satisfy a relation of S1<S2, in which S1 represents an area ratio of the high-luminance region in the first layer and S2 represents an area ratio of the high-luminance region in the second layer.

In the soft magnetic metal powder according to the present disclosure, S1 may satisfy 0.02≤S1≤0.98.

In the soft magnetic metal powder according the present disclosure, the oxide layer may have a thickness of 200 nm or less.

In the soft magnetic metal powder according to the present disclosure, the covering part may have an outer coating layer contacting a surface of the oxide layer.

A magnetic core according to the present disclosure includes the above-mentioned soft magnetic metal powder.

A magnetic component according to the present disclosure includes the above-mentioned soft magnetic metal powder.

An electronic device according to the present disclosure includes the above mentioned soft magnetic metal powder.

Hereinafter, a soft magnetic metal powder, etc., according to the embodiments of the present disclosure are described. In the figures used in the below description, a characteristic part may be enlarged for easier understanding of the characteristics of the present disclosure; hence, a proportion of the dimension of each configuration element may not precisely match the actual dimension. Materials, dimensions, etc., mentioned in below description are merely an example; and, the present disclosure is not limited to these. The materials, dimensions, etc., may change accordingly within the scope of the present disclosure as long as such change does not exceed the gist of the present disclosure.

A magnetic core according to the present embodiment includes the soft magnetic metal powder as a magnetic material.

Further, the magnetic core may include a resin. The resin may be any type, and the amount of the resin is not particularly limited. Examples of types of the resin include heat curable resins, such as a phenol resin and an epoxy resin. The amount of the resin may be 1 mass % or more and 5 mass % or less with respect to the amount of the magnetic powder.

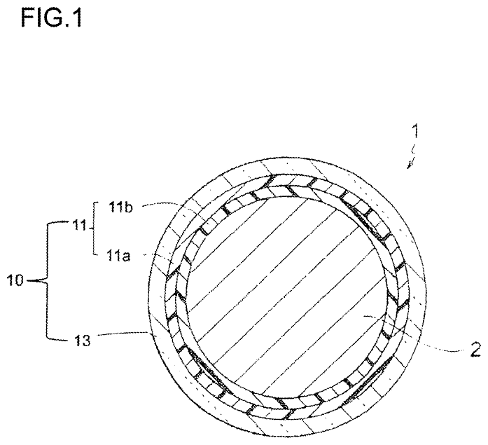

FIG. 1 shows a schematic cross-sectional view of a soft magnetic metal particle 1 included in the soft magnetic metal powder. As shown in FIG. 1, the soft magnetic metal particle 1 has a core part 2 and a covering part 10.

### (Core Part 2)

A composition of the core part 2 is not particularly limited as long as the core part 2 becomes a soft magnetic metal. For example, the core part 2 may be a composition which becomes an iron-based soft magnetic metal in which a total amount of Fe, Co, and Ni is 70 at % or greater, and a ratio of Fe is 50 at % or greater with respect to the total amount of Fe, Co, and Ni.

When the core part 2 is the iron-based soft magnetic metal, a coercivity Hc of the magnetic core is lowered, and a relative permeability of the magnetic core tends to improve.

The core part 2 is normally significantly larger than the covering part 10. The composition of the soft magnetic metal powder, the composition of the soft magnetic metal particle 1, and the composition of the core part 2 can be deemed substantially the same.

The soft magnetic metal powder may have any composition. Examples of the composition include a Fe—Co—B—P—Si—Cr-based composition, a Fe—Co—B—P—Si—Cr—C-based composition, a Fe—Si—B-based composition, a Fe—Si—B—C-based composition, a Fe—Si—B—C—Cr-based composition, a Fe—Co—P—C-based composition, a Fe—Co—B-based composition, and a Fe—Co—B—Si-based composition, which tend to form an amorphous structure. Also, other examples of the composition include a Fe—Si—B—Nb—Cu-based composition, a Fe—B—Nb—P-based composition, a Fe—Si—B—Nb—P-based composition, a Fe—Co—B—P—Si-based composition, and a Fe—Co—B—P—Si—Cr-based composition, which tend to form a nanocrystal structure. Further other examples of the composition include a Fe—Si-based composition, a Fe-based composition, a Fe—Ni-based composition, a Fe—Si—Cr-based composition, a Fe—Si—Al-based composition, a Fe—Si—Al—Ni-based composition, a Fe—Ni—Si—Co-based composition, a Fe—Co-based composition, a Fe—Co—V-based composition, a Fe—Co—Si-based composition, and a Fe—Co—Si—Al-based composition, which tend to form a crystal structure.

In the case that the soft magnetic metal powder includes one or more elements selected from the group consisting of Fe, Co, Ni, and Si, a ratio of total amount of Fe, Co, and Ni may be 70 at % or greater and 100 at % or less with respect to all of the elements included in the soft magnetic metal powder. A content ratio of Fe may be 50 at % or greater and 100 at % or less with respect to the ratio of total amount of Fe, Co, and Ni. A content ratio of Si may be greater than 0 at % and 20 at % or less with respect to all of the elements included in the soft magnetic metal powder. A ratio of total amount of other elements may be 0.1 at % or greater and 20 at % or less with respect to all of the elements included in the soft magnetic metal powder.

The composition of the soft magnetic metal particle 1 may be represented by a formula (Fe_{(1-(α+β)}X1_{α}X2_{β})_{(1-(a+b+c+d+e)} MₐB_{b}P_{c}SiₐCₑ which is in terms of an atomic ratio. X1 is one or more selected from the group consisting of Co and Ni; X2 is one or more selected from the group consisting of Al, Mn, Ag, Zn, Sn, As, Sb, Cu, Cr, Bi, N, O, S, and rare earth elements; and Mis one or more selected from the group consisting of Nb, Hf, Zr, Ta, Mo, W, Ti, and V. In the above formula, below relations are satisfied.

0≤a≤0.150,

0≤b≤0.200,

0≤c≤0.200,

0≤d≤0.200,

0≤e≤0.200,

0.100≤a+b+c+d+e≤0.300

α≥0,

β≥0, and

0<α+β<0.50.

When the composition satisfies the above-mentioned ranges, the coercivity tends to be lower, and a relative permeability tends to increase.

The soft magnetic metal particle 1 (core part 2) may include inevitable impurity elements other than the above-mentioned elements (Fe, X1, X2, M, B, P, Si, and C). For example, the soft magnetic metal particle (core part 2) may include 0.1 mass % or less of the inevitable impurity elements.

The core part 2 may have any fine structure. It may have an amorphous structure, a nanocrystal structure, or a crystal structure.

An amorphous structure refers to a structure having an amorphous ratio X of 85% or more. A structure which contains crystals to the extent that the amorphous ratio reaches 85% or greater is included in the amorphous structure. The amorphous structure includes an approximately amorphous structure or a hetero-amorphous structure. A hetero-amorphous structure refers to a structure in which crystals are present in an amorphous solid. When the core part 2 has a hetero-amorphous structure, the average crystal size of crystals in the amorphous solid may be 0.1 nm or greater and 10 nm or less. A nanocrystal structure refers to a structure having an amorphous ratio X of less than 85% and an average crystal size of 100 nm or less.

The average crystal size of the crystals in the nanocrystal structure may be 3 nm or greater and 50 nm or less. A crystal structure refers to a structure having an amorphous ratio X of less than 85% and an average crystal size of greater than 100 nm. The average crystal size can be verified by observing the cross section of the core part 2 using STEM.

The amorphous ratio X can be measured by an X-ray crystallography using XRD; or the amorphous ratio X may be measured using an electron backscattered diffraction (EBSD) or an electron diffraction. Hereinafter, a method of measuring the amorphous ratio by an X-ray crystallography using XRD will be described.

The amorphous ratio X of the soft magnetic metal powder is represented by Formula 1 shown below.

X=100−(Ic/(Ic+Ia)×100) Formula 1
Ic: Crystal scattering integrated intensity
Ia: Amorphous scattering integrated intensity

The amorphous ratio X is calculated as follows. An X-ray crystallography using XRD is conducted to the soft magnetic metal powder to identify phases, and peaks (Ic: crystal scattering integrated intensity, Ia: amorphous scattering integrated intensity) of crystallized Fe or a crystallized compound are read. From the intensities of these peaks, a crystallization ratio is determined, and the amorphous ratio X is calculated using the above-mentioned Formula 1. Below describes the calculation method in further detail.

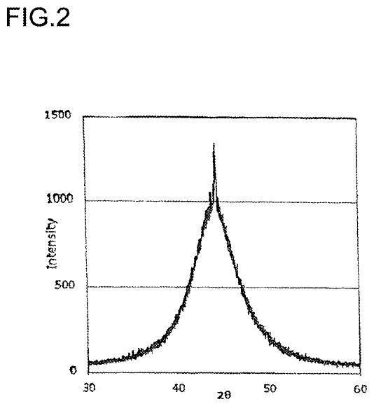

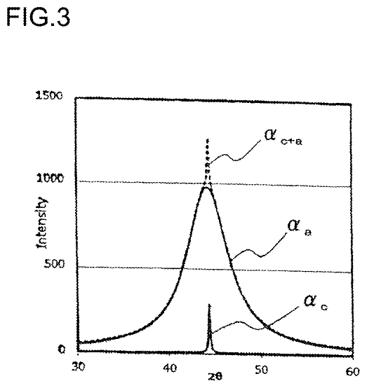

The X-ray crystallography using XRD is conducted to the soft magnetic metal powder to generate a chart like the one shown in FIG. 2. Then, profile fitting is conducted to this chart using a Lorentzian function shown in below Formula 2 to generate a crystal component pattern c showing the crystal scattering integrated intensity, an amorphous component pattern da showing the amorphous scattering integrated intensity, and a pattern acta showing a combination of these patterns, which are shown in FIG. 3. From the patterns of the crystal scattering integrated intensity and the amorphous scattering integrated intensity, the amorphous ratio X is calculated using the above-mentioned Formula 1. Note that, a measurement range of a diffraction angle 20 in which amorphous-derived halos can be confirmed is within a range of 20=30° to 60°. Within this range, the difference between the actual integrated intensities measured using XRD and the integrated intensities calculated using the Lorentzian function is within 1%.

$$f ( x ) = \frac{h}{1 + \frac{{( x - u )}^{2}}{{w}^{2}}} + b \qquad Formula 2$$

h: Peak height
u: Peak location
w: Full width at half maximum
b: Background height

An average particle size of the soft magnetic metal powder 1 is not particularly limited. For example, it may be 1 μm or larger and 100 μm or smaller. In the case of using the soft magnetic metal powder 1 with a small average particle size, the withstand voltage tends to become large and the variation in the withstand voltage tends to be small.

### (Covering Part 10)

The soft magnetic metal particle 1 according to the present embodiment includes the covering part 10 which contacts the surface of the core part 2. As shown in FIG. 1, the covering part 10 includes an oxide layer 11 which at least contacts a surface of the core part 2. Further, the oxide layer 11 has a second layer 11b which contacts the surface of the core part 2 and a first layer 11a which contacts the second layer 11b. Also, the first layer 11a and the second layer 11b include an oxide of an element included in the core part 2.

In the case that the core part 2 includes Fe and Si, the second layer 11b may include an oxide of Fe, and/or an oxide of Si. The oxide of Fe may be a simple oxide of Fe or a composite oxide including Fe. The oxide of Si may be a simple oxide of Si or a composite oxide including Si.

The first layer 11a may mainly include the oxide of Fe. The oxide of Fe may be a simple oxide of Fe or a composite oxide including Fe.

A content ratio of Si in the first layer 11a may be smaller than a content ratio of Si in the second layer 11b. For example, the content ratio of Si in the first layer 11a which is represented by Si1 and the content ratio of Si in the second layer 11b which is represented by Si2 may satisfy a relation of Si1<Si2.

In the case of observing the cross section of the soft magnetic metal particle 1 using HAADF-STEM, the first layer 11a shows uneven luminance distribution compared to the second layer 11b.

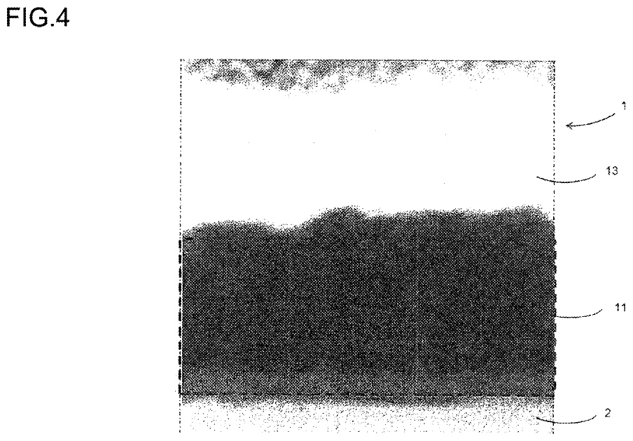

FIG. 4 shows the HAADF-STEM image which is obtained by actually observing the cross section of the soft magnetic metal particle 1 using HAADF-STEM. As shown in FIG. 4, the soft magnetic metal particle 1 includes the oxide layer 11 which contacts the surface of the core part 2. Further, the soft magnetic metal particle 1 includes an outer coating layer 13 which contacts a surface of the oxide layer 11. The outer coating layer 13 is described later. Note that, a layer on the surface of the outer coating layer 13 is a Pt-deposition layer which is adhered on the surface of the soft magnetic metal particle 1 in order to observe the soft magnetic metal particle 1 using HAADF-STEM.

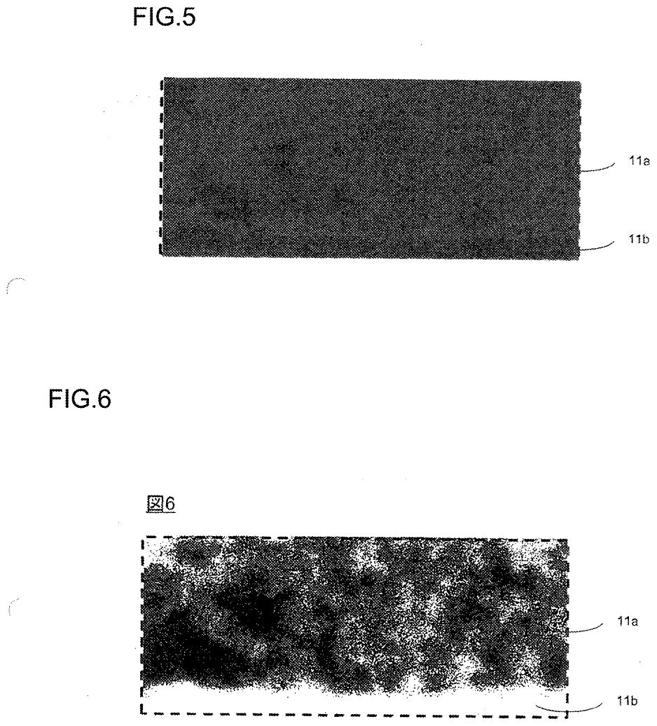

FIG. 5 is a partially enlarged figure of FIG. 4 which is an area surrounded by a bold broken line. As shown in FIG. 5, the first layer 11a has an uneven luminance distribution compared to the second layer 11b.

Further, FIG. 6 is a figure obtained by conducting Ohtsu's binarization (in below, this may be simply referred to as “binarization”) to a high-luminance region and a low-luminance region of FIG. 5. According to FIG. 6, the second layer 11b has an even luminance distribution only including a bright region (high-luminance region), and the first layer 11a has an uneven luminance distribution in which a bright region (high-luminance region) and a dark region (low-luminance region) co-exist.

The first layer 11a has a luminance distribution which is more uneven than that of the second layer 11b. A method for verifying this is described below.

Provided that a thickness of the first layer 11a is t1, an intermediate area of the first layer 11a is an area having a distance of 0.1×t1 or greater from boundaries between the first layer 11a and other parts (i.e., in FIG. 4 and FIG. 5, a boundary between the first layer 11a and the second layer 11b, and a boundary between the first layer 11a and the outer coating layer 13).

A first virtual line extending parallel to the surface of the core part 2 is drawn to the first layer 11a so as to pass through, in a length of 1000 nm, the intermediate layer along a thickness direction of the first layer 11a, and also drawn to the second layer 11b so as to pass through, in a length of 1000 nm, the second layer 11b. Then, the number of times that the high-luminance region and the low luminance region are observed alternatingly is counted; and the greater the number of observations, the more uneven the luminance distribution. When the first virtual line parallel to the surface of the core part 2 is drawn to the first layer 11a, in a length of 1000 nm, so as to pass through the intermediate part along the thickness direction of the first layer 11a, the high-luminance region and the low-luminance region may be observed twice or more in alternating manner along the first virtual line. Also, when it is not possible to draw a virtual line in a length of 1000 nm since the particle size of the soft magnetic metal particle 1 is small, a virtual line may be drawn in a length of r×π/2 or longer, in which “r” is the particle size.

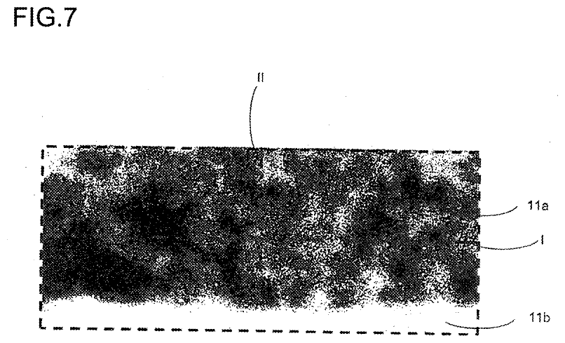

A line I shown in FIG. 7 is an example of the first virtual line drawn so as to pass through the intermediate layer in the thickness direction of the first layer 11a. In such case, the number of times that the high-luminance region and the low-luminance region are observed in alternating manner is clearly greater compared to the case of drawing the first virtual line parallel to the surface of the core part 2 on the second layer 11b. Further, the number times that the high-luminance region and the low-luminance region are observed in alternating manner along the first virtual line is twice or more.

Further, when a second virtual line perpendicular to the first virtual line is drawn so as to pass through the first layer 11a in a length which corresponds to the thickness of the first layer 11a, the high-luminance region and the low-luminance region may be observed in alternating manner twice or more along the second virtual line. In this case, the first layer 11a more clearly has an uneven luminance distribution.

A line II shown in FIG. 7 is an example of the second virtual line. The second virtual line is perpendicular to the first virtual line and is drawn so as to pass through the first layer 11a in a length corresponding to the thickness of the first layer 11a. Further, the number times that the high-luminance region and the low-luminance region are observed in alternating manner along the second virtual line is twice or more.

A length of the second virtual line is 0.8 times or greater and 1 times or less of the thickness of the first layer 11a.

The cause of the luminance differences between the first layer 11a and the second layer 11b in the HAADF-STEM image is not particularly limited. It may be caused by differences in compositions of the first layer 11a and the second layer 11b. Specifically, the compositions of the first layer 11a and the second layer 11b may be different by 5% or greater in terms of atomic ratio.

The reason having a different luminance (a high-luminance region and a low-luminance region) in the first layer 11a is not necessarily clear. The compositions of the high-luminance region and the low-luminance region may be substantially the same. That is, in the case of comparing the composition of the high-luminance region and the composition of low-luminance region without taking oxygen and carbon into consideration, when the difference in a content ratio of each element in each region is less than 5% in terms of number of atoms, the compositions in the regions may be deemed substantially the same.

The reason for having different luminance between the high-luminance region and the low-luminance region, even when the compositions are the same, is not necessarily clear. It is speculated that the difference may be caused by the differences in the densities of the high-luminance region and the low-luminance region. That is, when the high-luminance region and the low-luminance region have different densities, there is a difference in a transmission amount of electron beam between the high-luminance region and the low-luminance region. The difference in the transmission amount of the electron beam is thought as one possible cause of different luminance in the HAADF-STEM image.

When an area ratio of the high-luminance region in the first layer 11a is S1 and an area ratio of the high-luminance region in the second layer 11b is S2, S1 and S2 may satisfy a relation of S1<S2. Also, S2 and S1 may satisfy a relation of S2−S1≥0.01. Also, Si may be 0.02≤S1≤0.98. Note that, in the case shown in FIG. 4 to FIG. 7, S1 is within the range of 0.30 to 0.40, and S2 is 1. The boundary between the low-luminance region and the high-luminance region may be determined by conducting binarization so that S2 is 1 and S1 is at minimum; and thereby, S1 may be determined. Observation conditions of the HAADF-STEM image are not particularly limited. A magnification may be 1000000× and a resolution may be 1000 pixel/nm² or greater.

It is not particularly limited in regards with a content ratio of the soft magnetic metal particle having an uneven luminance distribution in the first layer 11a than in the second layer 11b with respect to the entire soft magnetic metal particles included in the soft magnetic metal powder. By observing the cross section of the soft magnetic metal particle included in the soft magnetic metal powder, it is possible to determine whether the soft magnetic metal particle has an uneven luminance distribution. Also, the content ratio of the soft magnetic metal particles having uneven luminance distribution in the soft magnetic metal powder may be 10% or greater in terms of the number of particles.

A thickness of the oxide layer 11 is not particularly limited. For example, it may be 200 nm or thinner, or 1 nm or thicker and 100 nm or thinner. A thickness of the first layer 11a is not particularly limited. For example, it may be 1 nm or thicker and 100 nm or thinner. A thickness of the second layer 11b is not particularly limited. For example, it may be 1 nm or thicker and 20 nm or thinner.

The covering part 10 of the soft magnetic metal particle 1 may further include, in addition to the oxide layer 11, the outer coating layer 13 contacting the surface of the oxide layer 11. A composition of the outer coating layer 13 is not particularly limited. For example, the outer coating layer 13 may be formed using a glass coating which is normally conducted in the technical field of the present disclosure. For example, the outer coating layer 13 may include a phosphate glass or a silica glass.

In the case that the soft magnetic metal particle 1 includes the outer coating layer 13, it is possible to further improve the withstand voltage.

Hereinafter, a method of manufacturing the soft magnetic metal powder according to the present embodiment will be described.

First, the soft magnetic metal powder including the soft magnetic metal particle which mainly becomes the core part 2 at the end is prepared. A method for preparing the soft magnetic metal powder is not particularly limited. For example, a commercially available soft magnetic metal powder may be prepared, or the soft magnetic metal powder may be made using atomization methods such as a water atomization method and a gas atomization method.

Whether the soft magnetic metal powder obtained using the atomization method has the amorphous structure or the crystal structure is primarily determined by the composition of the soft magnetic metal powder.

In the case that the soft magnetic metal powder obtained using the atomization method has the amorphous structure, nanocrystals having the crystal size of 5 nm or greater and 50 nm or less may precipitate by conducting a heat treatment; and in such case, the soft magnetic metal powder having the nanocrystal structure can be obtained. It also depends primarily on the composition of the soft magnetic metal powder whether the nanocrystals can be precipitated by the heat treatment.

For example, the conditions of the heat treatment are a temperature of 450 °C or higher and 650 °C or lower for 1 minute or longer and 180 minutes or less. Note that, one soft magnetic metal particle normally includes a number of nanocrystals. That is, the particle size of the soft magnetic metal particle and the crystal size of the nanocrystal are different. Also, the crystal structure of the soft magnetic metal powder can be verified using XRD or a transmission electron microscope. In the case that the soft magnetic metal powder includes the nanocrystals, Hc of the magnetic core obtained at the end tends to be lower and the relative permeability tends to be higher.

The average particle size of the soft magnetic metal powder can be adjusted by changing the conditions of the atomization method. Also, the average particle size of the soft magnetic metal powder can be adjusted using classification. Also, the average particle size may be adjusted by blending a plurality of types of soft magnetic metal powders having different average particle sizes.

Next, the covering part of the soft magnetic metal particle included in the soft magnetic metal powder is formed.

In the case of forming the oxide layer on the surface of the core part, any method may be used for forming the oxide layer. For example, the surface of the soft magnetic metal particle may be oxidized by performing the heat treatment under the atmosphere including oxygen. First, in the case of forming the second layer having a relatively even luminance distribution in the HAADF-STEM image on the surface of the core part, an oxygen concentration in the atmosphere is not particularly limited. For example, it may be 100 ppm to 10000 ppm. The heat treatment temperature is not particularly limited. For example, it may be 250 °C to 450 °C. The heat treatment time is not particularly limited. For example, it may be 0.5 hour to 10 hours. The higher the oxygen concentration, the higher the heat treatment temperature, and the longer the heat treatment time, the thicker the second layer tends to be.

Next, the first layer having a relatively uneven luminance distribution in the HAADF-STEM image is formed on the surface of the second layer.

Any method may be used for forming the first layer. For example, an oxidizing method by placing the soft magnetic metal powder under a high temperature high humidity atmosphere may be mentioned. A temperature for this method is not particularly limited. For example, it may be 50 °C to 95 °C A humidity for this method is not particularly limited. For example, it may be 60% to 90%. The treatment time for this method is not particularly limited. For example, it may be 1 hour to 1000 hours.

In the case that the soft magnetic metal particle includes Fe and Si, the second layer formed by conducting a heat treatment tends to include an oxide of Fe and an oxide of Si. In contrast, in the first layer formed by placing under a high temperature high humidity atmosphere, the oxide of Fe tends to be included more compared to the oxide of Si. In the case of forming the oxide layer under the high temperature high humidity atmosphere, Fe tends to be oxidized compared to Si. It is thought that this is caused because the element which easily oxidizes moves to the surface side.

The boundary between the first layer and the second layer may be determined based on a bright field image obtained using STEM. Also, a line profile may be conducted towards the surface of the soft magnetic metal particle from the core part to verify the change in luminance in the line profile. Thereby, the boundary between the first layer and the second layer may be verified. For example, an inflection point of the line profile may be deemed a boundary.

Any coating method may be used for forming the outer coating layer, and methods normally used in the technical field of the present disclosure may be used.

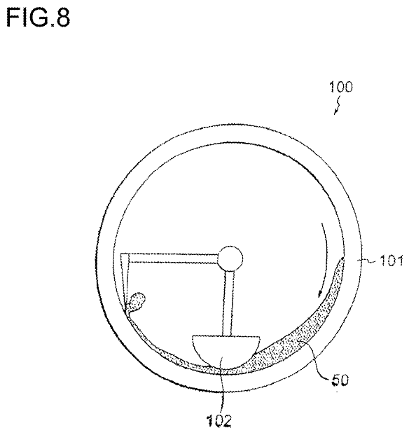

For example, dry coating may be conducted. In such case, materials of the outer coating layer are not particularly limited. For example, the outer coating layer made of a phosphate-based glass may be formed. In such case, the outer coating layer may be formed using a mechanical fusion method (a mechanical ironing method) which uses a powder coating device 100 shown in FIG. 8.

The soft magnetic metal powder to which the oxide layer has been formed is mixed with a phosphate-based glass powder to give a mixture 50. In such state, a rotor 101 is rotated, and the mixture 50 is compressed between a press-head 102 and an inner wall of the rotor 101 and heat is generated due to friction. Due to the friction heat generated, the phosphate-based glass is softened, and the phosphate-based glass adheres on the surface of the oxide layer by compression effect. Then, it is cooled and the outer coating layer is formed.

For example, wet coating may be also conducted. In such case, materials of the outer coating layer are not particularly limited. For example, the outer coating layer made of the oxide including Si may be formed by a sol-gel method using TEOS.

The magnetic powder used for forming the magnetic core is not particularly limited. The above-mentioned soft magnetic metal powder may be used as the magnetic powder, or another powder may be blended with the above-mentioned soft magnetic metal powder to form the magnetic powder.

The obtained magnetic powder is molded to give the magnetic core. Any method of molding may be used as the molding method. A method of obtaining the magnetic core using pressure-molding is explained as one example.

First, the magnetic powder and the resin are mixed. Mixing the powder with the resin makes it easier to give a molded body having high strength by molding. Types of the resin are not particularly limited. Examples of the resin include a phenol resin and an epoxy resin. The amount of the resin is not limited. When the resin is added, 1 mass % or more and 5 mass % or less of the resin may be added with respect to the magnetic powder.

A mixture of the soft magnetic metal powder and the resin is granulated to give a granulated powder. Any method of granulation may be used. For example, a stirrer may be used for granulation. The granulated powder may have any particle size.

The granulated powder is press molded to give the molded body. The pressure for the press molding is not limited. For example, a surface pressure may be 1 ton/cm² or greater and 10 ton/cm² or less. The higher the pressure for pressure molding, the higher the relative permeability tends to be, but the lower the withstand voltage tends to be.

In the case that the oxide layer 11 includes the first layer 11a and the second layer 11b, the withstand voltage is less likely to decrease even when the pressure for the press molding is increased. That is, by increasing the pressure for the press molding, the withstand voltage is maintained relatively high while easily achieving a high permeability.

Then, the resin included in the molded body is cured; and thereby, the magnetic core can be obtained. Any curing method may be used, and a heat treatment may be conducted under the conditions that can cure the resin.

The magnetic core may be used for any purpose. For example, the magnetic core can be suitably used as a magnetic core for an inductor, particularly for a power inductor. Moreover, the magnetic core can be suitably used also for an inductor which is obtained by integrally molding the magnetic core and a coil.

Further, the above-mentioned magnetic core and a magnetic component using the above-mentioned magnetic core can be suitably used for various electronic devices.

In particular, because the above-mentioned magnetic core has a high withstand voltage and has a small variation in the withstand voltage, the magnetic core is suitably used in fields in need of smaller size, lighter weight, and higher efficiency. For example, the above-mentioned magnetic core can be suitably used for a magnetic core, a magnetic component, and an electronic device mounted on hybrid-vehicles, plug-in hybrid-vehicles, and electric vehicles.

### EXAMPLES

Below describes the present disclosure in detail based on examples.

### Experiment Example 1

A soft magnetic metal powder having a type of composition shown in a column of “Core part composition” in Table 1 was formed. Specifically, ingots of various materials were prepared and weighed to obtain a molten metal having a target composition. Next, a chamber was vacuumed, and a crucible was heated by high-frequency induction using a work coil provided outside of the crucible to melt and mix the raw materials to give a molten metal (molten) having a temperature of 1400 °C to 1600 °C.

The obtained molten was supplied in a form of a linear continuous fluid into the chamber through a nozzle provided on a bottom of the crucible, and a gas was sprayed to the supplied molten; thereby, a powder was obtained. A spraying temperature of gas was 20 °C.

For Sample Nos. 17 to 20, the obtained powder was subjected to a heat treatment under inert atmosphere (in N₂ gas) at a temperature of 550 °C for 60 minutes. For Sample Nos. 21 to 24, the obtained powder was subjected to a heat treatment under inert atmosphere (in N₂ gas) at a temperature of 600 °C for 60 minutes.

The obtained powder was classified using a sieve. An average particle size of the powder was adjusted to about 25 μm through classification.

An ICP analysis was used to confirm that the composition of the molten metal and the composition of the soft magnetic metal powder were about the same.

Note that, the compositions of Sample Nos. 1 to 4 were 88.0Fe-12.0Si in terms of an atomic ratio. The compositions of Sample Nos. 5 to 8 were 72.7Fe-11.6Si-10.8B-2.2Cr-2.7C in terms of an atomic ratio. The compositions of Sample Nos. 9 to 12 were 63.2Fe-15.8Co-10.0B-5.0P-5.0Si-1.0Cr in terms of an atomic ratio. The compositions of Sample Nos. 13 to 16 were 62.5Fe-21.0Co-11.0B-4.0P-0.5Si-1.0C in terms of an atomic ratio. The compositions of Sample Nos. 17 to 20 were 73.5Fe-13.5Si-9.0B-3.0Nb-1.0Cu in terms of an atomic ratio. The compositions of Sample Nos. 21 to 24 were 79.0Fe-1.0Si-10.0B-7.0Nb-3.0P in terms of an atomic ratio. In the present examples, the compositions are all shown in terms of an atomic ratio.

A microstructure of each soft magnetic metal powder was verified using XRD. It was verified that Sample Nos. 1 to 4 had a crystal structure, Sample Nos. 5 to 16 had an amorphous structure, and Sample Nos. 17 to 24 had a nanocrystal structure. In each table shown below, a sample indicated “crystal” in the column of microstructure means that the sample had a crystal structure. A sample indicated “amorphous” means that the sample had an amorphous structure. A sample indicated “nanocrystal” means that the sample had a nanocrystal structure.

Next, an oxide layer was formed to the obtained powder.

Regarding the sample indicated “high heat 2” in the column of “2nd layer forming treatment”, a heat treatment was conducted at a temperature of 300 °C for one hour to form an oxide layer corresponding to a second layer. At this time, an oxygen concentration in the atmosphere was adjusted to 500 ppm.

On the oxide layer corresponding to the second layer of each example, an oxide layer corresponding to a first layer was formed. Regarding the sample indicated “high heat 1” in the column of “1st layer forming treatment”, a heat treatment was conducted at a temperature of 350 °C for one hour. At this time, an oxygen concentration in the atmosphere was adjusted to 1000 ppm. That is, the heat treatment conditions corresponding to “high heat 1” was a heat treatment condition which facilitate the oxidation more than the heat treatment condition corresponding to “high heat 2”. Regarding the sample indicated “high humidity” in the column of “1 st layer forming treatment”, such sample was left in the atmosphere having a temperature of 85 °C and humidity of 85% for 5 hours.

Next, a cylinder-shaped core was made using the obtained soft magnetic metal powder.

### (Measurement of Voltage Resistance V_{L} at Low Pressure)

The soft magnetic metal powder and the resin (phenol resin) were mixed. The resin was adjusted to be 3 mass % after mixing. Next, a generally used planetary mixer was used as a stirrer to obtain the granulated powder having a particle size of about 500 μm. Next, the obtained granulated powder was press-molded at a surface pressure of 4 ton/cm²; and thereby, a cylinder-shaped molded body having a diameter of 8 mmφ and a height of 8.0 mm was obtained. The obtained molded body was cured at 150 °C to form a cylinder-shaped core.

For each sample, twenty cylinder-shaped cores were formed. For each cylinder-shaped core, In—Ga electrodes were formed to two surfaces perpendicular to a thickness direction. Next, voltage was applied to the cylinder-shaped core using a source meter (THK-2011ADMPT made by TAMADENSOKU CO., LTD.), and the voltage was measured when the flowing current was 1 mA. Then, the measured voltage was divided by the thickness of the cylinder-shaped core; thereby, the withstand voltage of the cylinder-shaped core was measured. An average was calculated from the withstand voltages of twenty cylinder-shaped cores, and the obtained average was deemed V_{L} of each sample.

### (Measurement of Voltage Resistance V_{H} at High Pressure)

For measuring V_{H}, it was measured under the similar conditions as in the case of V_{L} except that the surface pressure was changed to 8 ton/cm².

### (Calculation of Reduction Rate of Withstand Voltage in Response to Increase in Pressure Force)

A reduction rate of the withstand voltage was calculated by 1−(V_{H}/V_{L}). The reduction rate of 24% or less was considered favorable, and 16% or less was considered more favorable.

### (Thickness of Each Layer)

The cross section of the soft magnetic metal particle of each sample was observed using STEM to obtain a HAADF-STEM image.

First, the soft magnetic metal powder was fixed on a Cu conductive tape. Then, a Pt spattering film was formed by spattering. A thickness of the Pt spattering film was about 20 nm.

Next, the soft magnetic metal powder fixed on the Cu conductive tape was placed on a focused ion beam probe NX 5000 made by HITACHI Hi-Tech Corporation. The fixed soft magnetic metal powder was observed to select the soft magnetic metal particle having a particle size which was the same as the average particle size of the soft magnetic metal powder. Then, using an electron beam deposition, a Pt deposition film having a thickness of about 100 nm was formed. Using an ion beam deposition thereon, a Pt deposition film having a thickness of about 2 μm was formed.

Then, a microsample was cut out which had a dimension of a transverse length of 10 μm, a vertical length of 10 μm, and a thickness of 1 μm so as to include a surface of the soft magnetic metal particle having a particle size which was the same as the average particle size of the soft magnetic metal powder. Then, the microsample was fixed on a Mo-grid. Then, it was thinned down using FIB until the thickness was 30 nm. STEM attached with spherical aberration correction was used for taking the HAADF-STEM image. A magnification of HAADF-STEM image was 2500000×.

Measurement points were set near the surface of the soft magnetic metal particle, and a thickness of each layer was measured to obtain the thickness of each layer. The same measurement was conducted to 10 soft magnetic metal particles, and an average of the obtained measurement values was used to calculate the thickness of each layer. Regarding the examples of Experiment example 1, i.e., Sample Nos. 4, 8, 12, 16, 20, and 24, it was confirmed that the thickness of the oxide layer (a total thickness of the first layer and the second layer) was about 50 nm. Also, for each example discussed in below, it was confirmed that the thickness of the oxide layer was about 50 nm, unless mentioned otherwise.

### (Measurement of S1 and S2, and Presence of Uneven Oxide Layer)

When the soft magnetic metal particle included the oxide layer, S1 and S2 were measured. Specifically, a HAADF-STEM image obtained by observing the oxide layer was binarized into a high-luminance region and a low-luminance region. For each example (Sample Nos. 4, 8, 12, 16, 20, and 24), the differences between the first layer and the second layer were clear due to the binarization. Further, S1 and S2 were calculated from the binarized image. In below described examples, S1=0.15 or greater and 0.50 or less, and S2=1; unless mentioned otherwise.

In contrast, for comparative examples, the HADDF-STEM image obtained by observing the oxide layer was unable to binarize using the differences in luminance.

Also, in the HAADF-STEM image, a first virtual line having a length of 1000 nm which was parallel to the surface of the core part was drawn on an intermediate part of the first layer. Further, a second virtual line, which was perpendicular to the first virtual line and had a length corresponding to the thickness of the first layer, was drawn inside the first layer. In the examples, the number of times that the high-luminance region and the low-luminance region were observed in alternating manner along the first virtual line was twice or more. Further, the number of times that the high-luminance region and the low-luminance region were observed in alternating manner along the second virtual line was twice or more. In contrast, even when a virtual line was drawn on an intermediate part of the second layer, a high-luminance region was not observed along said virtual line.

As discussed hereinabove, each example had S1<S2 and included the first layer containing the oxide layer having an uneven luminance distribution than the second layer. For the examples discussed in Experiment example 2 and after that, it was confirmed that each example had S1<S2 and the first layer contained the oxide layer having an uneven luminance distribution than the second layer.

TABLE 1

| | | | | | | Thickness | | | | |
|---|---|---|---|---|---|---|---|---|---|---|
| Sam- | Example/ | | | 2nd layer | 1st layer | of oxide | Uneven | | | 1 − |
| ple | Comparative | | Micro- | forming | forming | layer | oxide | V_{L} | V_{H} | (V_{H}/ |
| No. | example | Core part composition | structure | treatment | treatment | nm | layer | V/mm | V/mm | V_{L}) |
| 1 | Comparative | Fe—Si-based | Crystal | None | None | — | None | 107 | 75 | 30% |
| | example | | | | | | | | | |
| 2 | Comparative | Fe—Si-based | Crystal | High heat 2 | None | 2 | None | 181 | 116 | 36% |
| | example | | | | | | | | | |
| 3 | Comparative | Fe—Si-based | Crystal | High heat 2 | High heat 1 | 50 | None | 194 | 127 | 35% |
| | example | | | | | | | | | |
| 4 | Example | Fe—Si-based | Crystal | High heat 2 | high humidity | 50 | Observed | 193 | 166 | 14% |
| 5 | Comparative | Fe—Si—B—Cr—C-based | Amorphous | None | None | — | None | 106 | 76 | 28% |
| | example | | | | | | | | | |
| 6 | Comparative | Fe—Si—B—Cr—C-based | Amorphous | High heat 2 | None | 2 | None | 186 | 134 | 28% |
| | example | | | | | | | | | |
| 7 | Comparative | Fe—Si—B—Cr—C-based | Amorphous | High heat 2 | High heat 1 | 50 | None | 185 | 123 | 34% |
| | example | | | | | | | | | |
| 8 | Example | Fe—Si—B—Cr—C-based | Amorphous | High heat 2 | high humidity | 50 | Observed | 199 | 179 | 10% |
| 9 | Comparative | Fe—Co—B—P—Si—Cr-based | Amorphous | None | None | — | None | 105 | 77 | 27% |
| | example | | | | | | | | | |
| 10 | Comparative | Fe—Co—B—P—Si—Cr-based | Amorphous | High heat 2 | None | 2 | None | 185 | 134 | 28% |
| | example | | | | | | | | | |
| 11 | Comparative | Fe—Co—B—P—Si—Cr-based | Amorphous | High heat 2 | High heat 1 | 50 | None | 183 | 128 | 30% |
| | example | | | | | | | | | |
| 12 | Example | Fe—Co—B—P—Si—Cr-based | Amorphous | High heat 2 | high humidity | 50 | Observed | 199 | 180 | 10% |
| 13 | Comparative | Fe—Co—B—P—Si—C-based | Amorphous | None | None | — | None | 101 | 75 | 26% |
| | example | | | | | | | | | |
| 14 | Comparative | Fe—Co—B—P—Si—C-based | Amorphous | High heat 2 | None | 2 | None | 186 | 134 | 28% |
| | example | | | | | | | | | |
| 15 | Comparative | Fe—Co—B—P—Si—C-based | Amorphous | High heat 2 | High heat 1 | 50 | None | 185 | 123 | 34% |
| | example | | | | | | | | | |
| 16 | Example | Fe—Co—B—P—Si—C-based | Amorphous | High heat 2 | high humidity | 50 | Observed | 199 | 179 | 10% |
| 17 | Comparative | Fe—Si—B—Nb—Cu-based | Nanocrystal | None | None | — | None | 108 | 81 | 25% |
| | example | | | | | | | | | |
| 18 | Comparative | Fe—Si—B—Nb—Cu-based | Nanocrystal | High heat 2 | None | 2 | None | 176 | 115 | 35% |
| | example | | | | | | | | | |
| 19 | Comparative | Fe—Si—B—Nb—Cu-based | Nanocrystal | High heat 2 | High heat 1 | 50 | None | 177 | 116 | 34% |
| | example | | | | | | | | | |
| 20 | Example | Fe—Si—B—Nb—Cu-based | Nanocrystal | High heat 2 | high humidity | 50 | Observed | 188 | 167 | 11% |
| 21 | Comparative | Fe—Si—B—Nb—P-based | Nanocrystal | None | None | — | None | 108 | 77 | 29% |
| | example | | | | | | | | | |
| 22 | Comparative | Fe—Si—B—Nb—P-based | Nanocrystal | High heat 2 | None | 2 | None | 176 | 119 | 32% |
| | example | | | | | | | | | |
| 23 | Comparative | Fe—Si—B—Nb—P-based | Nanocrystal | High heat 2 | High heat 1 | 50 | None | 175 | 118 | 33% |
| | example | | | | | | | | | |
| 24 | Example | Fe—Si—B—Nb—P-based | Nanocrystal | High heat 2 | high humidity | 50 | Observed | 192 | 166 | 14% |

According to Table 1, in each example, the oxide layer included the first layer having an uneven luminance distribution than the second layer, and S1<S2 was satisfied. Further, in examples satisfying 0.02≤S1≤0.98, a reduction rate of the withstand voltage in response to the increase in the pressure force decreased. In contrast, each comparative example exhibited a high reduction rate of the withstand voltage in response to the increase in pressure force.

### Experiment Example 2

Experiment example 2 was conducted by varying the atmosphere condition during the first layer forming treatment in the range of humidity of 50% to 85%, and also varying the treatment time during the first layer forming treatment within 1 hour to 24 hours from those of Sample Nos. 4, 8, 12, 16, 20, and 24. The higher the humidity, the smaller the S1 tended to be, and the thicker the oxide layer tended to be. The longer the treatment time, the smaller the S1 tended to be, and the thicker the oxide layer tended to be. Using such properties, the thickness of the oxide layer was maintained around 50 nm, and S1 was varied. Results are shown in Table 2.

TABLE 2

| | Example/ | | | | | | |
|---|---|---|---|---|---|---|---|
| Sample | Comparative | | | | V_{L} | V_{H} | 1 − |
| No. | example | Core part composition | Microstructure | S1 | V/mm | V/mm | (V_{H}/V_{L}) |
| 3 | Comparative | Fe—Si-based | Crystal | — | 194 | 127 | 35% |
| | example | | | | | | |
| 25 | Example | Fe—Si-based | Crystal | 0.02 | 187 | 150 | 20% |
| 26 | Example | Fe—Si-based | Crystal | 0.10 | 188 | 159 | 15% |
| 4 | Example | Fe—Si-based | Crystal | 0.27 | 193 | 166 | 14% |
| 27 | Example | Fe—Si-based | Crystal | 0.58 | 188 | 165 | 12% |
| 28 | Example | Fe—Si-based | Crystal | 0.79 | 192 | 165 | 14% |
| 29 | Example | Fe—Si-based | Crystal | 0.98 | 194 | 149 | 23% |
| 7 | Comparative | Fe—Si—B—Cr—C-based | Amorphous | — | 185 | 123 | 34% |
| | example | | | | | | |
| 30 | Example | Fe—Si—B—Cr—C-based | Amorphous | 0.02 | 185 | 150 | 19% |
| 31 | Example | Fe—Si—B—Cr—C-based | Amorphous | 0.11 | 190 | 167 | 12% |
| 8 | Example | Fe—Si—B—Cr—C-based | Amorphous | 0.29 | 199 | 179 | 10% |
| 32 | Example | Fe—Si—B—Cr—C-based | Amorphous | 0.59 | 188 | 169 | 10% |
| 33 | Example | Fe—Si—B—Cr—C-based | Amorphous | 0.78 | 192 | 165 | 14% |
| 34 | Example | Fe—Si—B—Cr—C-based | Amorphous | 0.97 | 196 | 153 | 22% |
| 11 | Comparative | Fe—Co—B—P—Si—Cr-based | Amorphous | — | 183 | 128 | 30% |
| | example | | | | | | |
| 35 | Example | Fe—Co—B—P—Si—Cr-based | Amorphous | 0.02 | 184 | 152 | 17% |
| 36 | Example | Fe—Co—B—P—Si—Cr-based | Amorphous | 0.10 | 190 | 166 | 13% |
| 12 | Example | Fe—Co—B—P—Si—Cr-based | Amorphous | 0.30 | 199 | 180 | 10% |
| 37 | Example | Fe—Co—B—P—Si—Cr-based | Amorphous | 0.61 | 197 | 179 | 9% |
| 38 | Example | Fe—Co—B—P—Si—Cr-based | Amorphous | 0.79 | 192 | 170 | 11% |
| 39 | Example | Fe—Co—B—P—Si—Cr-based | Amorphous | 0.97 | 193 | 160 | 17% |
| 15 | Comparative | Fe—Co—B—P—Si—C-based | Amorphous | — | 185 | 123 | 34% |
| | example | | | | | | |
| 40 | Example | Fe—Co—B—P—Si—C-based | Amorphous | 0.02 | 186 | 152 | 18% |
| 41 | Example | Fe—Co—B—P—Si—C-based | Amorphous | 0.10 | 191 | 166 | 13% |
| 16 | Example | Fe—Co—B—P—Si—C-based | Amorphous | 0.29 | 199 | 179 | 10% |
| 42 | Example | Fe—Co—B—P—Si—C-based | Amorphous | 0.59 | 191 | 176 | 8% |
| 43 | Example | Fe—Co—B—P—Si—C-based | Amorphous | 0.77 | 191 | 170 | 11% |
| 44 | Example | Fe—Co—B—P—Si—C-based | Amorphous | 0.98 | 193 | 159 | 18% |
| 19 | Comparative | Fe—Si—B—Nb—Cu-based | Nanocrystal | — | 177 | 116 | 34% |
| | example | | | | | | |
| 45 | Example | Fe—Si—B—Nb—Cu-based | Nanocrystal | 0.03 | 191 | 157 | 18% |
| 46 | Example | Fe—Si—B—Nb—Cu-based | Nanocrystal | 0.11 | 184 | 166 | 10% |
| 20 | Example | Fe—Si—B—Nb—Cu-based | Nanocrystal | 0.28 | 188 | 167 | 11% |
| 47 | Example | Fe—Si—B—Nb—Cu-based | Nanocrystal | 0.57 | 189 | 165 | 13% |
| 48 | Example | Fe—Si—B—Nb—Cu-based | Nanocrystal | 0.79 | 194 | 167 | 14% |
| 49 | Example | Fe—Si—B—Nb—Cu-based | Nanocrystal | 0.98 | 198 | 153 | 23% |
| 23 | Comparative | Fe—Si—B—Nb—P-based | Nanocrystal | — | 175 | 118 | 33% |
| | example | | | | | | |
| 50 | Example | Fe—Si—B—Nb—P-based | Nanocrystal | 0.02 | 181 | 151 | 17% |
| 51 | Example | Fe—Si—B—Nb—P-based | Nanocrystal | 0.11 | 191 | 162 | 15% |
| 24 | Example | Fe—Si—B—Nb—P-based | Nanocrystal | 0.28 | 192 | 174 | 9% |
| 52 | Example | Fe—Si—B—Nb—P-based | Nanocrystal | 0.54 | 192 | 171 | 11% |
| 53 | Example | Fe—Si—B—Nb—P-based | Nanocrystal | 0.79 | 193 | 173 | 10% |
| 54 | Example | Fe—Si—B—Nb—P-based | Nanocrystal | 0.98 | 194 | 153 | 21% |

According to Table 2, in each example, even when S1 was varied, the reduction rate of the withstand voltage in response to the increase in the pressure force decreased. Particularly, in the case S1 was 0.10 or greater and 0.80 or less, the reduction rate of the withstand voltage decreased.

### Experiment Example 3

Experiment example 3 was conducted by changing the treatment time of the first layer forming time of Sample No. 12 in a range of 0.1 hour to 24 hours to vary the thicknesses of the oxide layer (thickness of the first layer was varied). Results are shown in Table 3.

TABLE 3

| | Example/ | | | Thickness of | | | |
|---|---|---|---|---|---|---|---|
| Sample | Comparative | Core part | | oxide layer | V_{L} | V_{H} | 1 − |
| No. | example | composition | Microstructure | nm | V/mm | V/mm | (V_{H}/V_{L}) |
| 55 | Example | Fe—Co—B—P—Si—Cr- | Amorphous | 3 | 159 | 135 | 15% |
| | | based | | | | | |
| 56 | Example | Fe—Co—B—P—Si—Cr- | Amorphous | 10 | 181 | 163 | 10% |
| | | based | | | | | |
| 12 | Example | Fe—Co—B—P—Si—Cr- | Amorphous | 50 | 199 | 180 | 10% |
| | | based | | | | | |
| 57 | Example | Fe—Co—B—P—Si—Cr- | Amorphous | 100 | 220 | 193 | 12% |
| | | based | | | | | |
| 58 | Example | Fe—Co—B—P—Si—Cr- | Amorphous | 200 | 238 | 208 | 13% |
| | | based | | | | | |

According to Table 3, in each example, even when the thickness of the oxide layer varied, the reduction rate of the withstand voltage in response to the increase in the pressure force decreased. Also, for each example of Experiment example 3, it was confirmed that the oxide layer included the second layer having a thickness of 2 nm and the first layer having an uneven oxide layer. Particularly, in the case that the thickness of the first layer (the uneven oxide layer) was 8 nm or greater, the reduction rate of the withstand voltage in response to the pressure force particularly decreased.

### Experiment Example 4

In Experiment example 4, coating was conducted to a soft magnetic metal powder prior to coating as shown in Tables 4A and 4B to form an outer coating layer; thereby, Sample Nos. 59 to 82 were formed.

### (Dry Coating (Phosphate Coating))

The soft magnetic metal powder and a phosphate-based glass (P—Zn—Al—O-based oxide glass) were together introduced into a powder coating device shown in FIG. 7. At this time, the amount of the phosphate-based glass was controlled so as to regulate the thickness of the outer coating layer to be about 20 nm, and the outer coating layer made of the phosphate-based glass was formed. Results are shown in Tables 4A and 4B.

### (Wet Coating (Si—Coating))

The outer coating layer made of an oxide including Si was formed by a sol-gel method using TEOS to the soft magnetic metal powder. At this time, the TEOS concentration was controlled so as to regulate the thickness of the outer coating layer to be about 20 nm. Results are shown in Tables 4A and 4B.

TABLE 4A

| | Example/ | | | | Outer | | | |
|---|---|---|---|---|---|---|---|---|
| Sample | Comparative | Sample No. | Core part | | coating | V_{L} | V_{H} | 1 − |
| No. | example | before coating | composition | Structure | layer | V/mm | V/mm | (V_{H}/V_{L}) |
| 2 | Comparative | 2 | Fe—Si-based | Crystal | None | 181 | 116 | 36% |
| | example | | | | | | | |
| 59 | Comparative | 2 | Fe—Si-based | Crystal | Phosphate | 375 | 276 | 26% |
| | example | | | | | | | |
| 60 | Comparative | 2 | Fe—Si-based | Crystal | Oxide | 339 | 208 | 39% |
| | example | | | | including Si | | | |
| 4 | Example | 4 | Fe—Si-based | Crystal | None | 193 | 166 | 14% |
| 61 | Example | 4 | Fe—Si-based | Crystal | Phosphate | 380 | 335 | 12% |
| 62 | Example | 4 | Fe—Si-based | Crystal | Oxide | 335 | 282 | 16% |
| | | | | | including Si | | | |
| 6 | Comparative | 6 | Fe—Si—B—Cr—C-based | Amorphous | None | 185 | 123 | 34% |
| | example | | | | | | | |
| 63 | Comparative | 6 | Fe—Si—B—Cr—C-based | Amorphous | Phosphate | 551 | 381 | 31% |
| | example | | | | | | | |
| 64 | Comparative | 6 | Fe—Si—B—Cr—C-based | Amorphous | Oxide | 480 | 328 | 32% |
| | example | | | | including Si | | | |
| 8 | Example | 8 | Fe—Si—B—Cr—C-based | Amorphous | None | 199 | 179 | 10% |
| 65 | Example | 8 | Fe—Si—B—Cr—C-based | Amorphous | Phosphate | 550 | 499 | 9% |
| 66 | Example | 8 | Fe—Si—B—Cr—C-based | Amorphous | Oxide | 480 | 405 | 16% |
| | | | | | including Si | | | |
| 10 | Comparative | 10 | Fe—Co—B—P—Si—Cr-based | Amorphous | None | 185 | 134 | 28% |
| | example | | | | | | | |
| 67 | Comparative | 10 | Fe—Co—B—P—Si—Cr-based | Amorphous | Phosphate | 550 | 370 | 33% |
| | example | | | | | | | |
| 68 | Comparative | 10 | Fe—Co—B—P—Si—Cr-based | Amorphous | Oxide | 490 | 321 | 34% |
| | example | | | | including Si | | | |
| 12 | Example | 12 | Fe—Co—B—P—Si—Cr-based | Amorphous | None | 199 | 180 | 10% |
| 69 | Example | 12 | Fe—Co—B—P—Si—Cr-based | Amorphous | Phosphate | 530 | 480 | 9% |
| 70 | Example | 12 | Fe—Co—B—P—Si—Cr-based | Amorphous | Oxide | 480 | 408 | 15% |
| | | | | | including Si | | | |

TABLE 4B

| | Example/ | | | | Outer | | | |
|---|---|---|---|---|---|---|---|---|
| Sample | Comparative | Sample No. | Core part | | coating | V_{L} | V_{H} | 1 − |
| No. | example | before coating | composition | Structure | layer | V/mm | V/mm | (V_{H}/V_{L}) |
| 14 | Comparative | 14 | Fe—Co—B—P—Si—C-based | Amorphous | None | 186 | 134 | 28% |
| | example | | | | | | | |
| 71 | Comparative | 14 | Fe—Co—B—P—Si—C-based | Amorphous | Phosphate | 520 | 354 | 32% |
| | example | | | | | | | |
| 72 | Comparative | 14 | Fe—Co—B—P—Si—C-based | Amorphous | Oxide | 470 | 311 | 34% |
| | example | | | | including Si | | | |
| 16 | Example | 16 | Fe—Co—B—P—Si—C-based | Amorphous | None | 199 | 179 | 10% |
| 73 | Example | 16 | Fe—Co—B—P—Si—C-based | Amorphous | Phosphate | 510 | 470 | 8% |
| 74 | Example | 16 | Fe—Co—B—P—Si—C-based | Amorphous | Oxide | 480 | 401 | 16% |
| | | | | | including Si | | | |
| 18 | Comparative | 18 | Fe—Si—B—Nb—Cu-based | Nanocrystal | None | 185 | 123 | 34% |
| | example | | | | | | | |
| 75 | Comparative | 18 | Fe—Si—B—Nb—Cu-based | Nanocrystal | Phosphate | 422 | 288 | 32% |
| | example | | | | | | | |
| 76 | Comparative | 18 | Fe—Si—B—Nb—Cu-based | Nanocrystal | Oxide | 390 | 265 | 32% |
| | example | | | | including Si | | | |
| 20 | Example | 20 | Fe—Si—B—Nb—Cu-based | Nanocrystal | None | 199 | 179 | 10% |
| 77 | Example | 20 | Fe—Si—B—Nb—Cu-based | Nanocrystal | Phosphate | 416 | 364 | 13% |
| 78 | Example | 20 | Fe—Si—B—Nb—Cu-based | Nanocrystal | Oxide | 385 | 333 | 14% |
| | | | | | including Si | | | |
| 22 | Comparative | 22 | Fe—Si—B—Nb—Cu-based | Nanocrystal | None | 176 | 119 | 32% |
| | example | | | | | | | |
| 79 | Comparative | 22 | Fe—Si—B—Nb—Cu-based | Nanocrystal | Phosphate | 411 | 284 | 31% |
| | example | | | | | | | |
| 80 | Comparative | 22 | Fe—Si—B—Nb—Cu-based | Nanocrystal | Oxide | 377 | 263 | 30% |
| | example | | | | including Si | | | |
| 24 | Example | 24 | Fe—Si—B—Nb—Cu-based | Nanocrystal | None | 192 | 166 | 14% |
| 81 | Example | 24 | Fe—Si—B—Nb—Cu-based | Nanocrystal | Phosphate | 423 | 368 | 13% |
| 82 | Example | 24 | Fe—Si—B—Nb—Cu-based | Nanocrystal | Oxide | 378 | 321 | 15% |
| | | | | | including Si | | | |

According to Table 4, in each example, even when the outer coating layer was formed, the reduction rate of the withstand voltage decreased in response to the increase in the pressure force.

### Experiment Example 5

Experiment example 5 was conducted under the same conditions as Sample Nos. 67 and 69 except that the average particle size of the soft magnetic metal powder was changed.

Results are shown in Table 6. Note that, in the case that the average particle size of the soft magnetic metal powder was 1 μm to 10 μm, the soft magnetic metal particle was embedded in the resin for curing. Then, a microsample was cut out. Specifically, the soft magnetic metal particle was fixed in the Mo-grid, and the microsample was cut out. Other than mentioned here, the experiment was conducted similar to the case which the particle size of the soft magnetic metal particle was 25 μm.

TABLE 5

| | | | | Metal | | | | | |
|---|---|---|---|---|---|---|---|---|---|
| | Example/ | | | particle | Uneven | Outer | | | |
| Sample | Comparative | Core part | | size | oxide | coating | V_{L} | V_{H} | 1 − |
| No. | example | composition | Microstructure | μm | layer | layer | V/mm | V/mm | (V_{H}/V_{L}) |
| 83 | Comparative | Fe—Co—B—P—Si—Cr- | Amorphous | 1 | None | Phosphate | 931 | 632 | 32% |
| | example | based | | | | | | | |
| 84 | Comparative | Fe—Co—B—P—Si—Cr- | Amorphous | 3 | None | Phosphate | 832 | 556 | 33% |
| | example | based | | | | | | | |
| 85 | Comparative | Fe—Co—B—P—Si—Cr- | Amorphous | 10 | None | Phosphate | 610 | 408 | 33% |
| | example | based | | | | | | | |
| 67 | Comparative | Fe—Co—B—P—Si—Cr- | Amorphous | 25 | None | Phosphate | 550 | 370 | 33% |
| | example | based | | | | | | | |
| 86 | Comparative | Fe—Co—B—P—Si—Cr- | Amorphous | 50 | None | Phosphate | 351 | 218 | 38% |
| | example | based | | | | | | | |
| 87 | Example | Fe—Co—B—P—Si—Cr- | Amorphous | 1 | Observed | Phosphate | 1210 | 1090 | 10% |
| | | based | | | | | | | |
| 88 | Example | Fe—Co—B—P—Si—Cr- | Amorphous | 3 | Observed | Phosphate | 932 | 832 | 11% |
| | | based | | | | | | | |
| 89 | Example | Fe—Co—B—P—Si—Cr- | Amorphous | 10 | Observed | Phosphate | 680 | 598 | 12% |
| | | based | | | | | | | |
| 69 | Example | Fe—Co—B—P—Si—Cr- | Amorphous | 25 | Observed | Phosphate | 530 | 480 | 9% |
| | | based | | | | | | | |
| 90 | Example | Fe—Co—B—P—Si—Cr- | Amorphous | 50 | Observed | Phosphate | 498 | 435 | 13% |
| | | based | | | | | | | |

According to Table 5, in each example, even when the average particle size varied, the reduction rate of the withstand voltage decreased in response to the increase in the pressure force.

### Experiment Example 6

In Experiment example 6, Sample Nos. 91 to 110 were conducted similarly to Sample Nos. 2 and 4 except for changing the composition (core part composition) of the soft magnetic metal powder. The compositions of the soft magnetic metal powders of Sample Nos. 91 and 92 substantially only included Fe. For Sample Nos. 93 and 94, the compositions were adjusted so that an atomic ratio was 55.0Fe-45.0Ni. For Sample Nos. 95 and 96, the compositions were adjusted so that an atomic ratio was 89.4Fe-8.6Si-2.0Cr. For Sample Nos. 97 and 98, the compositions were adjusted so that an atomic ratio was 73.7Fe-16.4Si-9.9Al. For Sample Nos. 99 and 100, the compositions were adjusted so that an atomic ratio was 78.1Fe-11.0Si-10.0Al-0.9Ni. For Sample Nos. 101 and 102, the compositions were adjusted so that an atomic ratio was 49.2Fe-42.0Ni-4.0Si-4.8Co. For Sample Nos. 103 and 104, the compositions were adjusted so that an atomic ratio was 50.0Fe-50.0Co. For Sample Nos. 105 and 106, the compositions were adjusted so that an atomic ratio was 49.0Fe-49.0Co-2.0V. For Sample Nos. 107 and 108, the compositions were adjusted so that an atomic ratio was 83.6Fe-4.4Co-12.0Si. For Sample Nos. 109 and 110, the compositions were adjusted so that an atomic ratio was 66.3Fe-7.4Co-16.4Si-9.9Al. Results are shown in Table 6A.

Sample Nos. 111 to 122 were conducted similarly to Sample Nos. 6, 8, 10, 12, 14, and 16 except for changing the composition (core part composition) of the soft magnetic metal powder. For Sample Nos. 111 and 112, the compositions were adjusted so that an atomic ratio was 81.6Fe-3.4Si-13.4B-1.6C. For Sample Nos. 115 and 116, the compositions were adjusted so that an atomic ratio was 72.3Fe-18.2Si-9.5B. For Sample Nos. 117 and 118, the compositions were adjusted so that an atomic ratio was 56.0Fe-24.0Co-15.0P-5.0C. For Sample Nos. 119 and 120, the compositions were adjusted so that an atomic ratio was 56.0Fe-24.0Co-20.0B. For Sample Nos. 121 and 122, the compositions were adjusted so that an atomic ratio was 56.0Fe-24.0Co-15.0B-5.0Si. Results are shown in Table 6B.

Sample Nos. 123 to 126 were conducted similarly to Sample Nos. 18, 20, 22, and 24 except for changing the composition (core part composition) of the soft magnetic metal powder. For Sample Nos. 123 and 124, the compositions were adjusted so that an atomic ratio was 63.2Fe-15.8Co-11.0B-9.0P-1.0Si. For Sample Nos. 125 and 126, the compositions were adjusted so that an atomic ratio was 63.2Fe-15.8Co-10.0B-5.0P-5.0Si-1.0Cr. Results are shown in Table 6C.

TABLE 6A

| | Example/ | | | Uneven | | | |
|---|---|---|---|---|---|---|---|
| Sample | Comparative | Core part | | oxide | V_{L} | V_{H} | 1 − |
| No. | example | composition | Microstructure | layer | V/mm | V/mm | (V_{H}/V_{L}) |
| 2 | Comparative | Fe—Si-based | Crystal | None | 181 | 116 | 36% |
| | example | | | | | | |
| 4 | Example | Fe—Si-based | Crystal | Observed | 193 | 166 | 14% |
| 91 | Comparative | Fe-based | Crystal | None | 177 | 118 | 33% |
| | example | | | | | | |
| 92 | Example | Fe-based | Crystal | Observed | 192 | 164 | 15% |
| 93 | Comparative | Fe—Ni-based | Crystal | None | 178 | 119 | 33% |
| | example | | | | | | |
| 94 | Example | Fe—Ni-based | Crystal | Observed | 194 | 165 | 15% |
| 95 | Comparative | Fe—Si—Cr-based | Crystal | None | 177 | 112 | 37% |
| | example | | | | | | |
| 96 | Example | Fe—Si—Cr-based | Crystal | Observed | 196 | 166 | 15% |
| 97 | Comparative | Fe—Si—Al-based | Crystal | None | 181 | 115 | 36% |
| | example | | | | | | |
| 98 | Example | Fe—Si—Al-based | Crystal | Observed | 188 | 162 | 14% |
| 99 | Comparative | Fe—Si—Al—Ni-based | Crystal | None | 184 | 112 | 39% |
| | example | | | | | | |
| 100 | Example | Fe—Si—Al—Ni-based | Crystal | Observed | 191 | 168 | 12% |
| 101 | Comparative | Fe—Ni—Si—Co-based | Crystal | None | 178 | 115 | 35% |
| | example | | | | | | |
| 102 | Example | Fe—Ni—Si—Co-based | Crystal | Observed | 192 | 165 | 14% |
| 103 | Comparative | Fe—Co-based | Crystal | None | 185 | 113 | 39% |
| | example | | | | | | |
| 104 | Example | Fe—Co-based | Crystal | Observed | 194 | 162 | 16% |
| 105 | Comparative | Fe—Co—V-based | Crystal | None | 180 | 112 | 38% |
| 106 | Example | Fe—Co—V-based | Crystal | Observed | 194 | 162 | 16% |
| 107 | Comparative | Fe—Co—Si-based | Crystal | None | 176 | 113 | 36% |
| | example | | | | | | |
| 108 | Example | Fe—Co—Si-based | Crystal | Observed | 192 | 167 | 13% |
| 109 | Comparative | Fe—Co—Si—Al-based | Crystal | None | 178 | 115 | 35% |
| | example | | | | | | |
| 110 | Example | Fe—Co—Si—Al-based | Crystal | Observed | 193 | 167 | 13% |

TABLE 6B

| | Example/ | | | | | | |
|---|---|---|---|---|---|---|---|
| Sample | Comparative | Core part | | Uneven | V_{L} | V_{H} | 1 − |
| No. | example | composition | Microstructure | oxide layer | V/mm | V/mm | (V_{H}/V_{L}) |
| 6 | Comparative | Fe—Si—B—Cr—C-based | Amorphous | None | 186 | 134 | 28% |
| | example | | | | | | |
| 8 | Example | Fe—Si—B—Cr—C-based | Amorphous | Observed | 199 | 179 | 10% |
| 10 | Comparative | Fe—Co—B—P—Si—Cr-based | Amorphous | None | 185 | 134 | 28% |
| | example | | | | | | |
| 12 | Example | Fe—Co—B—P—Si—Cr-based | Amorphous | Observed | 199 | 180 | 10% |
| 14 | Comparative | Fe—Co—B—P—Si—C-based | Amorphous | None | 186 | 134 | 28% |
| | example | | | | | | |
| 16 | Example | Fe—Co—B—P—Si—C-based | Amorphous | Observed | 199 | 179 | 10% |
| 111 | Comparative | Fe—Si—B—C-based | Amorphous | None | 188 | 138 | 27% |
| | example | | | | | | |
| 112 | Example | Fe—Si—B—C-based | Amorphous | Observed | 194 | 179 | 8% |
| 113 | Comparative | Fe—Co—B—P—Si—Cr-based | Amorphous | None | 185 | 134 | 28% |
| | example | | | | | | |
| 114 | Example | Fe—Co—B—P—Si—Cr-based | Amorphous | Observed | 199 | 180 | 10% |
| 115 | Comparative | Fe—Si—B-based | Amorphous | None | 189 | 138 | 27% |
| | example | | | | | | |
| 116 | Example | Fe—Si—B-based | Amorphous | Observed | 20 | 176 | 12% |
| 117 | Comparative | Fe—Co—P—C-based | Amorphous | None | 189 | 130 | 31% |
| | example | | | | | | |
| 118 | Example | Fe—Co—P—C-based | Amorphous | Observed | 199 | 177 | 11% |
| 119 | Comparative | Fe—Co—B-based | Amorphous | None | 182 | 134 | 26% |
| | example | | | | | | |
| 120 | Example | Fe—Co—B-based | Amorphous | Observed | 197 | 177 | 10% |
| 121 | Comparative | Fe—Co—B—Si-based | Amorphous | None | 183 | 135 | 26% |
| | example | | | | | | |
| 122 | Example | Fe—Co—B—Si-based | Amorphous | Observed | 201 | 178 | 11% |

TABLE 6C

| | Example/ | | | Uneven | | | |
|---|---|---|---|---|---|---|---|
| Sample | Comparative | Core part | | oxide | V_{L} | V_{H} | 1 − |
| No. | example | composition | Microstructure | layer | V/mm | V/mm | (V_{H}/V_{L}) |
| 18 | Comarative | Fe—Si—B—Nb—Cu-based | Nanocrystal | None | 176 | 115 | 35% |
| | example | | | | | | |
| 20 | Example | Fe—Si—B—Nb—Cu-based | Nanocrystal | Observed | 188 | 167 | 11% |
| 22 | Comarative | Fe—Si—B—Nb—P-based | Nanocrystal | None | 176 | 119 | 32% |
| | example | | | | | | |
| 24 | Example | Fe—Si—B—Nb—P-based | Nanocrystal | Observed | 192 | 166 | 14% |
| 123 | Comarative | Fe—Co—B—P—Si-based | Nanocrystal | None | 177 | 118 | 33% |
| | example | | | | | | |
| 124 | Example | Fe—Co—B—P—Si-based | Nanocrystal | Observed | 186 | 163 | 12% |
| 125 | Comarative | Fe—Co—B—P—Si—Cr-based | Nanocrystal | None | 179 | 116 | 35% |
| | example | | | | | | |
| 126 | Example | Fe—Co—B—P—Si—Cr-based | Nanocrystal | Observed | 186 | 164 | 12% |

According to Tables 6A to 6C, in each example, even when the compositions of the soft magnetic metal powders were varied, the reduction rate of the withstand voltage in response to the increase in the pressure force decreased.

### REFERENCE SIGNS LIST

1 . . . . Soft magnetic metal particle
2 . . . . Core Part
10 . . . . Covering Part
11 . . . . Oxide layer
11a . . . . First layer
11b . . . . Second layer
13 . . . . Outer coating layer
50 . . . . Mixture
100 . . . . Powder coating device
101 . . . . Rotor
102 . . . . Press head

What is claimed is:

1. A soft magnetic metal powder, comprising:
a soft magnetic metal particle comprising a core part and a covering part,
wherein the soft magnetic metal particle comprises Fe,
the covering part comprises an oxide layer contacting a surface of the core part,
the oxide layer comprises a second layer contacting the surface of the core part and a first layer contacting the second layer,
the first layer and the second layer comprise an oxide of an element included in the core part, and
the first layer has an uneven luminance distribution compared to the second layer in a cross section of the soft magnetic metal particle observed using HAADF-STEM.

2. The soft magnetic metal particle according to claim 1, wherein a binarized image having a high-luminance region and a low-luminance region obtained by observing the cross section of the soft magnetic metal particle using HAADF-STEM satisfy a relation of S1<S2, in which S1 represents an area ratio of the high-luminance region in the first layer and S2 represents an area ratio of the high-luminance region in the second layer.

3. The soft magnetic metal powder according to claim 2, wherein S1 satisfies 0.02≤S1≤0.98.

4. The soft magnetic metal powder according to claim 1, wherein the oxide layer has a thickness of 200 nm or less.

5. The soft magnetic metal powder according to claim 1, wherein the covering part comprises an outer coating layer contacting a surface of the oxide layer.

6. A magnetic core comprising the soft magnetic metal powder according to claim 1.

7. A magnetic component comprising the soft magnetic metal powder according to claim 1.

8. An electronic device comprising the soft magnetic metal powder according to claim 1.
